(19) United States
(12) Patent Application Publication
(10) Pub. No.: US 2005/0000199 A1
(43) Pub. Date: Jan. 6, 2005

(54) Baffle filter

(75) Inventor: Thomas Eric Carter, Maplewood, NJ (US)

Correspondence Address: FITZPATRICK CELLA HARPER & SCINTO, 30 ROCKEFELLER PLAZA, NEW YORK, NY, 10112, US

(73) Assignee: Caddy Corporation, Bridgeport, NJ (US)

(21) Appl. No.: 10/855,909

(22) Filed: May 26, 2004

Related U.S. Application Data
(60) Provisional application No. 60/473,149, filed on May 27, 2003.

(51) Int. Cl. B01D 45/00

(52) U.S. Cl. 55/442

(57) ABSTRACT

An apparatus is provided for filtering pollutants from exhaust air. The apparatus includes a baffle filter, at least one inlet flow plate, and at least one outlet flow plate. The baffle filter has an inlet-side and an outlet-side, and includes a plurality of baffle channels. The at least one inlet flow plate attaches to the inlet-side of the baffle filter and covers a portion of the plurality of baffle channels. The at least one outlet flow plate attaches to the outlet-side of the baffle filter and covers another portion of the plurality of baffle channels.

This application claims the benefit of U.S. Provisional Application No. 60/473,149, filed May 27, 2003, the disclosure of which is hereby incorporated by reference in its entirety, as if fully set forth herein.

### BACKGROUND OF THE INVENTION

1. Field of the Invention

The present invention relates to an improved baffle filter for filtering grease, fat, and other pollutants from exhaust air.

2. Description of the Related Art

A hood with an exhaust fan is positioned above most kitchen cooking elements (stoves, ranges, ovens, etc.) for venting smoke, steam, grease, fat, and the like away from the cooking area. To trap the grease, fat, and other pollutants (hereinafter generally referred to as “pollutants”) before reaching the exhaust fan, a filter is positioned between the hood opening and the exhaust fan. Typical commercial-grade filters include baffle filters and cartridge filters.

FIG. 1 depicts a cross-sectional view of a conventional baffle filter 1. As shown in FIG. 1, the conventional baffle filter 1 consists of a frame 2, whose width and length varies depending on the dimensions of the hood and has a depth of approximately 2 inches, a plurality of overlapping upper channels 3 and lower channels 4 extending between two sides of the frame (not shown), and may consist of one or more troughs at the end of the lower channels 4 to collect the trapped pollutants. Each upper channel 3, relative to the opposing lower channel 4, has a ceiling 5 and two walls 6 that extend downward. Each lower channel 4 has a floor 7 and two walls 8 that extend upward, forming a “gutter”. The upper and lower channels are positioned to create a circuitous air flow (see FIG. 1) through the baffle filter 1, where the linear distance of the air flow is approximately 3 to 4 inches, as measured in the width-height plane. The inlet velocity of the exhaust air in a conventional baffle filter is approximately 600 feet per minute (fpm). As the exhaust air passes through the baffle filter 1, particles of pollutants may collide with the surfaces of the upper channels 3 and adhere thereto. Because of the slant of the walls of the upper channels 3, most of the particles of pollutants on the upper channel 3 surfaces slide down into the “gutters” of the lower channels 4. Other particles of pollutants may collide with the surfaces of the lower channels 4 and adhere thereto. Still other particles of pollutants that do not adhere to either the upper or lower channel surfaces, may exit the baffle filter 1.

Conventional baffle filters have drawbacks. First, because the depth of a conventional filter is approximately 2 inches, the baffle filter provides a relatively small fire barrier. Second, because linear air flow distance is only 3 to 4 inches, coupled with the low intake velocity, only an average amount of pollutants are removed from the exhaust air.

FIGS. 2 and 3 depict a front view and a cross-sectional view, respectively, of a conventional cartridge filter. The cartridge filter 9 comprises a filter housing 10 that includes a back wall 11, a front wall 12 spaced from the back wall 11, a right wall 20 connected between the back wall 11 and the front wall 12, and a left wall 21 connected between the back wall 11 and the front wall 12 and spaced from the right wall 20. The spacing between the right wall 20 and the left wall 21 varies on the length of the hood.

The back wall 11 includes a protrusion 13 from the lower end of the back wall forward towards the front wall 12 with an extension 14 directed in a generally vertical direction. The lower portion of the front wall 12 is spaced above the extension 14 creating an exhaust air inlet opening 22. A rear air flow diverter 15, connected to the upper portion of the back wall 11, extends forward from the back wall towards the front wall 12. The rear air flow diverter 15 includes, at the forward edge, a front baffle 16.

The front wall 12 includes a protrusion 17 extending from the upper end of the front wall back towards the back wall 11. The protrusion 17 is spaced above the upper portion of the back wall 11, creating an exhaust air outlet opening 23. A forward air flow diverter 18, connected to the lower portion of the front wall 12, extends back towards the back wall 11 and includes, at the back edge, a back baffle 19.

As depicted in FIG. 3, the exhaust air enters the exhaust air inlet opening 22 and collides with the forward air flow diverter 18 and the back baffle 19, causing a change in direction, downward and towards the back wall 11, of the exhaust air. This also causes pollutants to adhere to the various surfaces, thus separating the pollutants from the exhaust air. The direction of the exhaust air is then changed by approximately 180 degrees, circumventing the forward air flow diverter 18. This causes the exhaust air to collide with the rear air flow diverter 15 and the front baffle 16, further separating the pollutants from the air. The direction of the exhaust air is again changed, circumventing the rear air flow diverter 15 and front baffle 16, and exiting through the exhaust air outlet opening 23. At each change in direction of the exhaust air flow, pollutants are separated from the exhaust air.

The dimensions of a conventional cartridge filter are greater than those of a conventional baffle filter. The conventional cartridge filter, as shown in FIGS. 2 and 3, has a depth, the maximum distance of the space between the back wall 11 and the front wall 12, of approximately 6 inches, a length ranging from 8 inches to 14 inches, and a width that is dependent upon the dimensions of the hood. As such, the conventional cartridge filter is larger and bulkier than the above-described conventional baffle filter, and thus provides a relatively larger fire barrier. The conventional cartridge filter also provides a longer linear air flow distance of between 8 and 20 inches for the exhaust air to circulate, allowing better removal of the pollutants. Moreover, certain conventional cartridge filters have a slot intake design that are capable of handling intake velocities of 1000 fpm and higher, thus providing better removal efficiency of pollutants in the exhaust air. However, the large and bulky size makes the conventional cartridge filter inconvenient to install, use, clean, and store.

### SUMMARY OF THE INVENTION

An object of the present invention is to provide an exhaust baffle filter that combines the benefits of conventional cartridge filters while maintaining the smaller physical profile of conventional baffle filters.

It is another object of the present invention to provide a retrofitting kit to existing baffle filters, resulting in baffle filters that combine the benefits of conventional cartridge filters while maintaining the smaller physical profile of conventional baffle filters.

In order to achieve the above objects, according to one aspect of the present invention, an apparatus is provided for filtering pollutants from exhaust air. The apparatus includes a baffle filter, at least one inlet flow plate, and at least one outlet flow plate. The baffle filter has an inlet-side and an outlet-side, and includes a plurality of baffle channels. The at least one inlet flow plate attaches to the inlet-side of the baffle filter and covers a portion of the plurality of baffle channels. The at least one outlet flow plate attaches to the outlet-side of the baffle filter and covers another portion of the plurality of baffle channels.

According to another aspect of the present invention, a kit is provided for use with a baffle filter having an inlet-side, an outlet-side, and a plurality of baffle channels. The kit includes at least one inlet flow plate capable of being attached to the inlet-side of the baffle filter to cover a portion of the baffle channels, and at least one outlet flow plate capable of being attached to the outlet-side of the baffle filter to cover another portion of the plurality of baffle channels.

Still another aspect of the present invention is a method for attaching at least one inlet flow plate and at least one outlet flow plate onto a baffle filter having an inlet-side and an outlet-side, and a plurality of baffle channels. The method includes the steps attaching the at least one inlet flow plate to the inlet-side of the baffle filter, covering a portion of the plurality of baffle channels, and attaching the at least one outlet flow plate to the outlet-side of the baffle filter, covering another portion of the plurality of baffle channels.

Further objects, features, and advantages of the present invention will become apparent from the following description of the preferred embodiments with reference to the attached drawings.

### BRIEF DESCRIPTION OF THE DRAWINGS

FIG. 1 is a cross-sectional view of a conventional baffle filter;

FIG. 2 is a front view of a conventional cartridge filter

FIG. 3 is a cross-sectional view of a conventional cartridge filter;

FIG. 4 is a sectional view of an embodiment of the present invention;

FIG. 5 is sectional view of an embodiment of the present invention showing the flow of exhaust air through the filter;

FIG. 6 is a cross-sectional view of kitchen hood with a filter of the present invention installed;

FIGS. 7A-7C are respectively front, cross-section, and rear views showing preferred dimensions of the present invention; and

FIG. 8 is sectional view of an embodiment of the present invention showing two inlet plates and one outlet plate.

### DESCRIPTION OF THE PREFERRED EMBODIMENTS

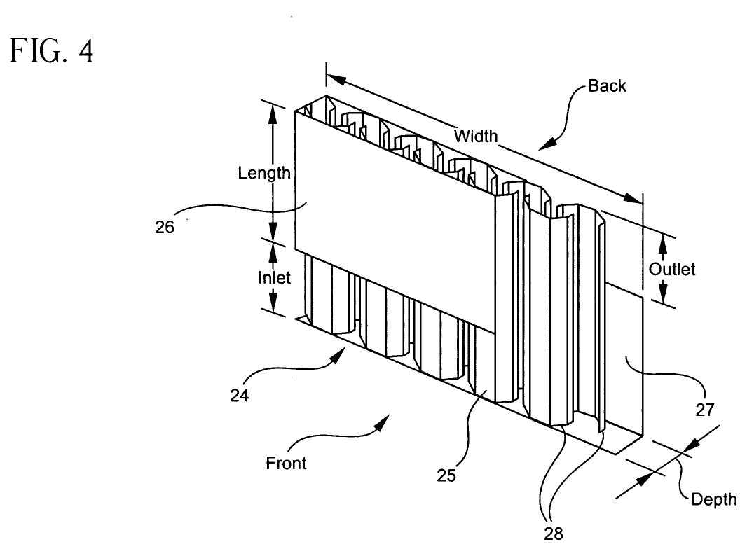

FIG. 4 is a sectional view of a filter 24 according to an embodiment of the invention. The filter 24 includes, as configured in FIG. 4, a baffle filter 25 consisting of more than one baffle channels 28, one or more inlet plates 26 that restricts the amount of exhaust air intake into the baffle filter 25 by reducing the intake area, and one or more outlet plates 27 that restricts the amount of exhaust air out take by reducing the outlet area of the baffle filter 25.

The inlet outlet plates may be composed of fire resistant material, such as galvanized or stainless steel, and/or equivalent materials that are well known in the art, such as plate materials (copper, brass, cold rolled steal, etc.) and/or heat resistant composites. The plates have a width that is approximately equal to the width of the baffle filter. The length of the plates is less than the total length of the baffle. The length of the inlet plate 26 does not have to be equal to the length of the outlet plate 27, and the length of both, the inlet and outlet plates may be adjustable. Both kinds of plates are attached to the baffle filter frame, such that the intake and outlet openings can change from the ends to the middle or any where along the length of the baffle filter so as to provide the most effective capture and transfer of exhaust air depending on the cooking application and hood configuration. The plates may be substantially permanently affixed to the baffle filter, such as by tack welding or rivets, and/or may be removably attached by screws, snap-in screws, clips, etc. The plates may be optionally removable to allow for detailed cleaning or refitting the system for different slot locations, for example, if the cooking equipment changes.

In one embodiment, the inlet plate 26, which restricts the intake of the exhaust air into the baffle filter 25, is attached to the front, upper portion of the baffle filter 25 as shown in FIG. 4, such that the lower portions of the baffle channels 28 are visible, allowing exhaust air to enter only the lower portion of the baffle filter 25.

The outlet plate 27, which restricts the venting of the exhaust air out of the baffle filter 25, is attached to the rear, lower portion of the baffle filter 25 as shown in FIG. 4, such that the upper portions of the baffle channels 28 are visible, allowing exhaust air to exit only the upper portion of the baffle filter 25.

The length of both kinds of plates is greater than half the length of the baffle filter 25, but less than the total length of the baffle filter 25.

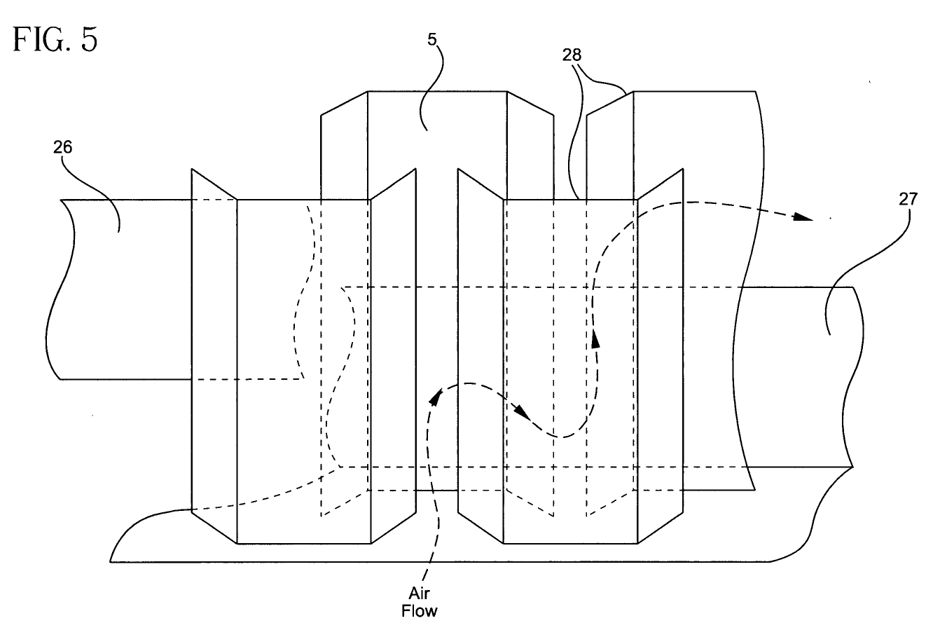

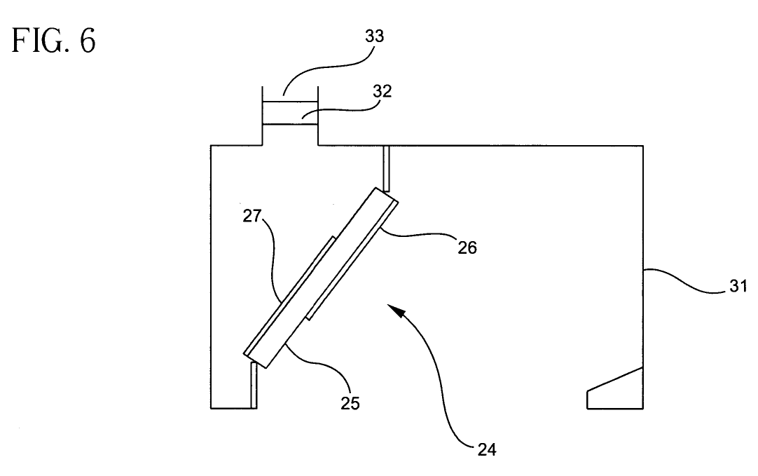

The operation of the filter 24 (FIG. 5 depicting the air flow), with an inlet plate and outlet plate attached, will now be described. It should be kept in mind that the filter 24 will be attached to a hood 31 (FIG. 6) above heating elements (not shown) and that a fan 32 (FIG. 6) draws exhaust air from above the heating elements through the filter 24 and out from the hood through an exhaust duct 33.

As shown in FIG. 5, the exhaust air enters the inlet opening of the filter, which area is smaller relative to that of a conventional baffle filter by the installation of the inlet plate 26, and collides with the ceiling 5 of the upper baffle channels, causing pollutants to separate from the air. The exhaust air flow is diverted to the walls of the upper baffle channels and then to the floor of the lower baffle channels, where the collisions with the baffle channels separates more and more pollutants from the air. The floors of the lower baffle channels change the exhaust air flow direction such that the exhaust air flow exits the baffle channels and strikes the inside surface of the outlet plate 27. This collision causes the first of two additional turns in the exhaust air flow, as compared to the exhaust air flow in a conventional baffle filter, forcing the exhaust air flow upwards in a generally vertical direction along the inside of the outlet plate 27 until the upper edge of the outlet plate 27 is reached. At this point, the exhaust air flow makes the second additional turn, in a generally horizontal direction out the back of the filter. At each turn in the air flow, and along the inside surface of the outlet plate 27, pollutants are separated from the air.

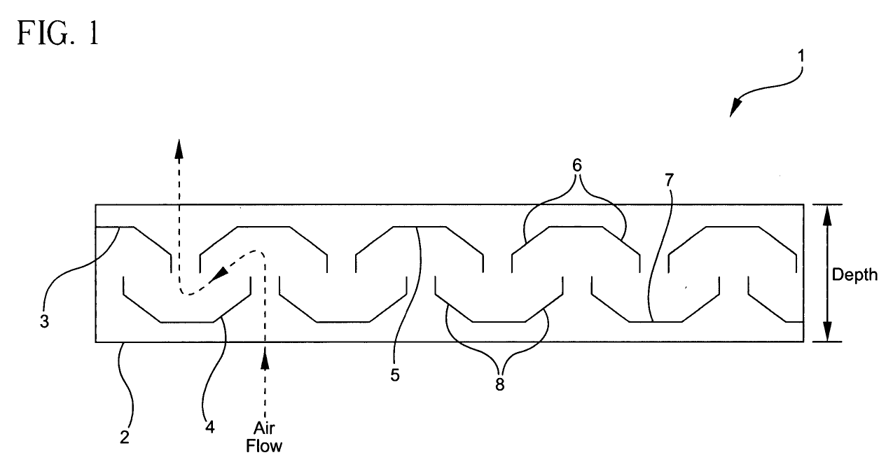

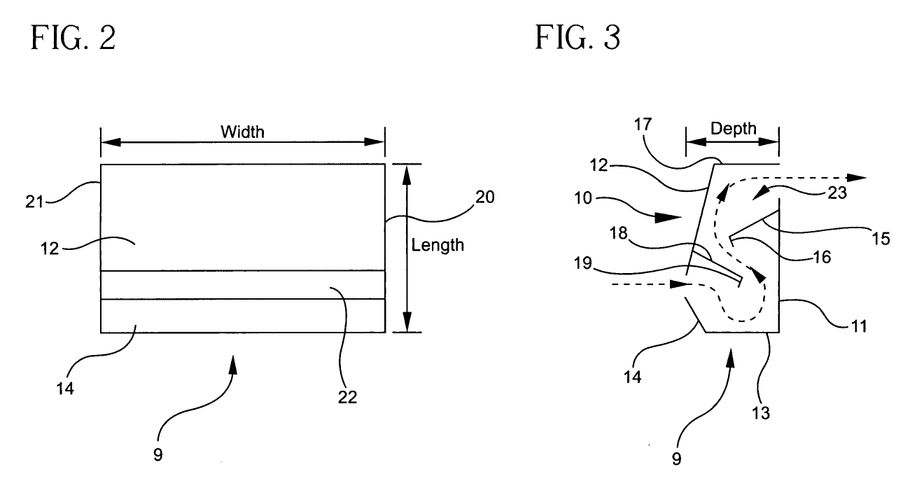

By virtue of the feature that the inlet and the outlet plates have a length greater than half the length of the baffle filter, the inlet plate 26 and the outlet plate 27 cover an overlapping plurality of baffle channels 28, thereby increasing the length of the circuitous air flow through the filter and introducing two additional turns, i.e., a vertical turn and then a horizontal turn, in the air flow, as compared to the air flow through a conventional baffle filter as depicted in FIG. 1. Depending on the length of the inlet and outlet plates, the linear air flow can be extended to 8 to 14 inches, or even more, within the filter. Also, because of the reduced area of the intake and outlet openings and the additional resistance introduced to the air flow by the additional turns, the exhaust intake (air flow) velocity is increased. Thus, by restricting the inlet and outlet areas of the baffle filter 25, and elongating the exhaust air flow through the filter 24, the filter 24 can achieve substantially similar pollutant removal efficiency as that of a conventional cartridge filter, without the bulkiness of the cartridge filter. Further, the inlet plate 26 and the outlet plate 27 provide a greater fire barrier protection than that provided by a conventional baffle filter.

The inlet and outlet plates may be attached in other configurations. For example, the inlet plate may be attached to the front, lower portion of the baffle filter, and the outlet plate may be attached to the rear, upper portion of the baffle filter.

Other configurations may consist of splitting the inlet plate 26 and/or outlet plate 27 to allow the intake and outlet of the filter 24 to change positions.

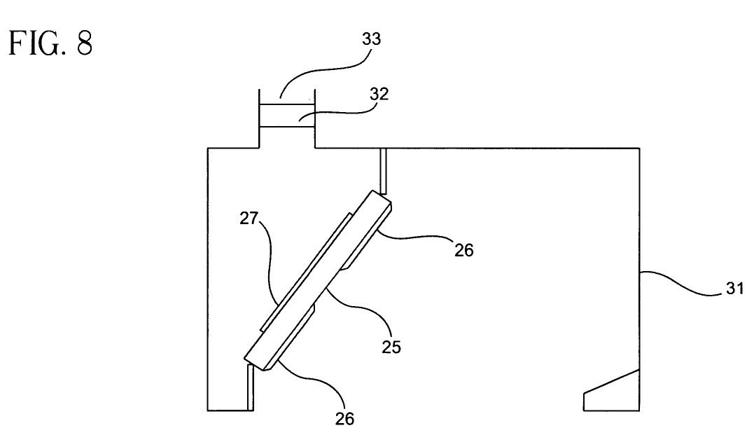

Another embodiment includes attaching two inlet plates 26 to either end of the of the front of the baffle filter, such that the baffle channels 28 in the middle of the baffle filter are visible, allowing exhaust air to enter only the middle of the baffle filter 25, as shown in FIG. 8. This configuration may be reversed with a single inlet plate at the middle of the baffle filter and two outlet plates at the ends of the baffle filter (not shown). In addition, multiple inlet and outlet plates in a variety of configurations may be used. In general, the slot opening locations can change from the ends to the middle, and vice versa, or anywhere along the plate length to allow the inlet and outlet locations to be positioned along the vertical face of the filter to provide the most effective capture and transfer of exhaust air into the exhaust duct, depending on the cooking equipment, cooking application, and the hood configuration.

The outlet plate 27 is attached to the rear, middle of the baffle filter 25 as shown in FIG. 8, such that the baffle channels 28 at both ends of the baffle filter are visible, allowing exhaust air to exit only the ends of the baffle filter 25.

Each inlet plate 26 covers a plurality of baffle channels 28 which are also covered by the outlet plate 27, thereby, increasing the length of the circuitous air flow through the filter and introducing additional turns, i.e., vertical turns and then horizontal turns, in the air flow, as compared to the air flow through a conventional baffle filter as depicted in FIG. 1.

The filter 24 operates as follows. Exhaust air enters the inlet opening of the filter, in the middle of the baffle filter 25, which area is smaller relative to that of a conventional baffle filter by the installation of the inlet plates 26, and collides with the ceiling 5 of the upper baffle channels, causing pollutants to separate from the air. The exhaust air flow is diverted to the walls of the upper baffle channels and then to the floor of the lower baffle channels, where the collisions with the baffle channels separates more and more pollutants from the air. The floors of the lower baffle channels change the exhaust air flow direction such that the exhaust air flow exits the baffle channels and strikes the inside surface of the outlet plate 27. This collision causes the first of two additional turns in the exhaust air flow, as compared to the exhaust air flow in a conventional baffle filter, forcing the exhaust air flow upwards or downwards in a generally vertical direction along the inside of the outlet plate 27 until the upper/lower edge of the outlet plate 27 is reached. At this point, the exhaust air flow makes another additional turn, in a generally horizontal direction out the back of the filter. At each turn in the air flow, and along the inside surface of the outlet plate 27, pollutants are separated from the air.

Another embodiment of the present invention is to retrofit existing baffle filters with inlet and outlet plates. Conventional baffle filters may be retrofitted by attaching one or more inlet plates 26 to the intake side of the baffle filter and one or more outlet plates 27 to the outlet side of the baffle filter.

For example, a conventional baffle filter 25 may be retrofitted with an inlet plate 26 attached to the front, upper portion of the baffle filter 25 as shown in FIG. 4, such that the lower portions of the baffle channels 28 are visible, and allowing exhaust air to enter only the lower portion of the baffle filter.

Further, outlet plate 27 may be attached to the rear, lower portion of the baffle filter 25 as shown in FIG. 4, such that the upper portions of the baffle channels 28 are visible, allowing exhaust air to exit only the upper portion of the baffle filter.

The operation (flow of exhaust) of a retrofitted conventional baffle filter according to the present embodiment is substantially similar as that of the filter 24 described above. Thus, by attaching the inlet plate 26 and the outlet plate 27 onto a conventional baffle filter, as described above, the benefits of obtained by the filter 24 may also be realized by a retrofitted conventional baffle filter.

Conventional baffle filters 25 may also be retrofitted by attaching inlet and outlet plates in other configurations, as described above.

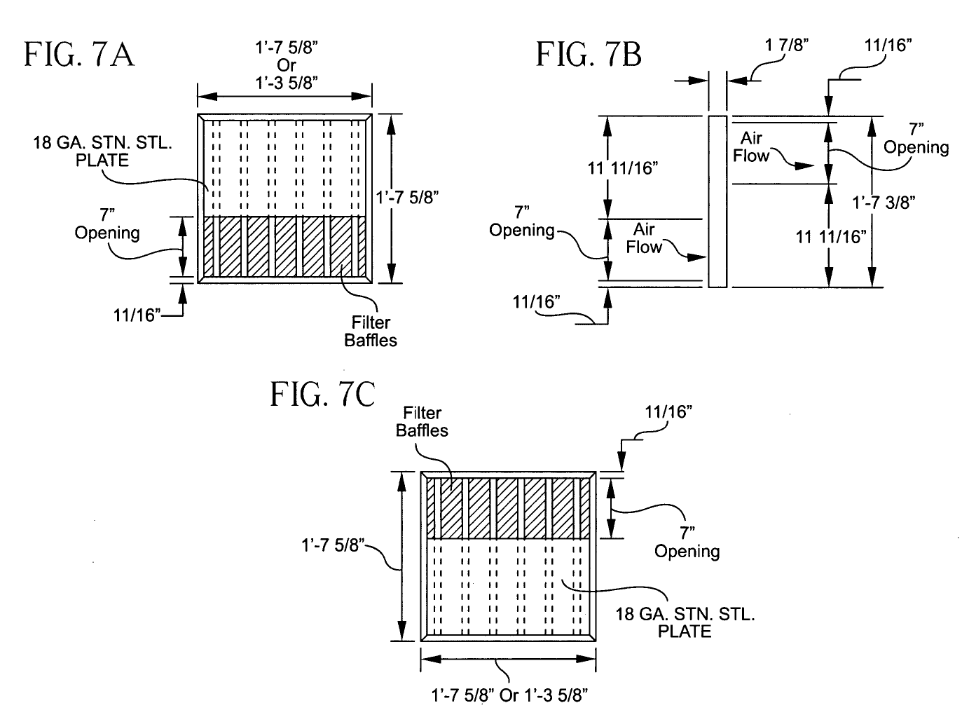

FIGS. 7A-7C depict front, section, and rear views showing preferred dimensions of the baffle filter, including the inlet and outlet plates, of the present invention.

While the present invention has been described with reference to what are considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. An apparatus for filtering pollutants from exhaust air, the apparatus comprising:
a baffle filter comprising of a plurality of baffle channels, the baffle filter having an inlet-side and an outlet-side;
at least one inlet flow plate attached to the inlet-side of the baffle filter and covering a portion of the plurality of baffle channels; and
at least one outlet flow plate attached to the outlet-side of the baffle filter and covering another portion of the plurality of baffle channels.

2. An apparatus according to claim 1, wherein the at least one inlet flow plate is attached to a first end of the baffle filter, and the at least one outlet flow plate is attached to a second end of the baffle filter opposite to the first end of the baffle filter.

3. An apparatus according to claim 1, wherein the widths of the inlet and outlet flow plates are substantially equal to the width of the baffle filter, and the lengths of the inlet and outlet flow plates are less than the length of the baffle filter.

4. An apparatus according to claim 1, wherein the inlet and outlet flow plates are made of a fire resistant material.

5. An apparatus according to claim 4, wherein the inlet and outlet flow plates are made of one or more of the groups of materials including galvanized steel, stainless steel, copper, brass, cold rolled steel, and heat resistant composites.

6. An apparatus according to claim 1, wherein the inlet and outlet flow plates cover an overlapping plurality of baffle channels.

7. A kit for use with a baffle filter having an inlet-side, an outlet-side, and a plurality of baffle channels, the kit comprising:
at least one inlet flow plate capable of being attached to the inlet-side of the baffle filter to cover a portion of the plurality of baffle channels; and
at least one outlet flow plate capable of being attached to the outlet-side of the baffle filter to cover another portion of the plurality of baffle channels.

8. A kit according to claim 7, wherein the at least one inlet flow plate is capable of being attached to a first end of the baffle filter, and the at least one outlet flow plate is capable of being attached to a second end of the baffle filter opposite to the first end of the baffle filter.

9. A kit according to claim 7, wherein the widths of the inlet and outlet flow plates are substantially equal to the width of the baffle filter, and the lengths of the inlet and outlet flow plates are less than the length of the baffle filter.

10. A kit according to claim 7, wherein the inlet and outlet flow plates are made of a fire resistant material.

11. A kit according to claim 10, wherein the inlet and outlet flow plates are made of one or more of the groups of materials including galvanized steel, stainless steel, copper, brass, cold rolled steel, and heat resistant composites.

12. A kit according to claim 7, wherein the inlet and outlet flow plates cover an overlapping plurality of baffle channels.

13. A method for attaching at least one inlet flow plate and at least one outlet flow plate onto a baffle filter having an inlet-side, an outlet-side, and a plurality of baffle channels, the method comprising the steps of:
attaching the at least one inlet flow plate to the inlet-side of the baffle filter, such that the at least one inlet flow plate covers a portion of the plurality of baffle channels; and
attaching the at least one outlet flow plate to the outlet-side of the baffle filter, such that the at least one outlet flow plate covers another portion of the plurality of baffle channels.

14. A method according to claim 13, wherein the at least one inlet flow plate is attached to a first end of the baffle filter, and the at least one outlet flow plate is attached to a second end of the baffle filter opposite to the first end of the baffle filter.

15. A method according to claim 13, wherein the widths of the inlet and outlet flow plates are substantially equal to the width of the baffle filter, and the lengths of the inlet and outlet flow plates are less than the length of the baffle filter.

16. A method according to claim 13, wherein the inlet and outlet flow plates are made of a fire resistant material.

17. A method according to claim 16, wherein the inlet and outlet flow plates are made of one or more of the groups of materials including galvanized steel, stainless steel, copper, brass, cold rolled steel, and heat resistant composites.

18. A method according to claim 13, wherein the inlet and outlet flow plates cover an overlapping plurality of baffle channels.
